(19) United States
(12) Patent Application Publication
(10) Pub. No.: US 2003/0221989 A1
(43) Pub. Date: Dec. 4, 2003

(54) Cleanup aid

(76) Inventor: Frederick Henry DeSanti, Huntington Station, NY (US)

Correspondence Address: Island Patent, 12 Rutgers Road, Farmingville, NY, 11738, US

(21) Appl. No.: 10/159,309

(22) Filed: May 31, 2002

(51) Int. Cl. B65D 85/62

(52) U.S. Cl. 206/554; 206/449

(57) ABSTRACT

A cleanup aid including a plurality of sack forming sheets, with each sack forming sheet available for use in securing a volume of debris. The sack forming sheets may be provided as a stack of sheets, with one sheet superposing and covering a next sheet in the stack. A volume of debris may be placed upon a center portion of an upper surface of a fully deployed sack forming sheet. Next, the corners and other edge proximate portions may be lifted, bunched, and secured, thereby forming a sack containing the volume of debris. The invention may include a protective ground contacting tarp that is located between a ground surface and the sack forming sheets. The tarp may include a grasping portion that may be utilized by an individual for moving the cleanup aid about a selected area containing debris to be secured and removed.

### TECHNICAL FIELD

The present invention relates to cleanup devices and methods of use. More particularly, the invention relates to a cleanup aid that is quite useful for enabling an individual to readily and easily secure a volume of debris, including yard debris such as leaves, small twigs, branches, etc., in a sack formed of one of an available plurality of sack forming sheets.

### BACKGROUND ART

The periodic need to gather and dispose of yard debris is well understood, especially during the Spring and Fall seasons. Typical clean up tasks may be carried out by homeowners, town workers, lawn and field maintenance crews, and other individuals. Often these cleanup tasks can be quite arduous and time consuming. In many cases the collected debris need to be placed in large plastic or paper bags for removal.

As an example, consider a residential setting where a homeowner needs to collect a volume of yard debris. In this setting, the volume of debris would typically include leaves, small twigs, hedge trimmings, and or lawn cuttings. The homeowner would typically rake or blow the debris into a pile. Next, the debris would be gradually forced into one or more large bags for removal. When considering a cleaning up of Fall leaves that have fallen from trees, a dozen or more large bags of leaves may easily result. Skilled individuals will fully understand that the act of placing collected debris into a plurality of bags can be a time consuming and back breaking task—with a significant amount of the total work time spent physically getting the debris into the bags. Accordingly, an alternative arrangement enabling debris to be more easily secured for removal in a reduced amount of time would be most desirable.

It may be noted that a method of disposal wherein collected volumes of yard debris are placed along curb-side or other arranged locations for pickup is presently being phased out by many local municipalities. There are a number of environmental and safety reasons forcing this change in policy. These include clogging of storm drains and sewers, slippery road and sidewalk surfaces, and constricting of the passable width of roads and walk ways.

Accordingly, it would be most desirable to have a means structured such that a volume of debris may be collected, and rapidly secured within a suitable container (e.g., a sack) for ready removal. A number of other characteristics, advantages, and or associated novel features of the present invention, will become clear from the description and figures provided herein. Attention is called to the fact, however, that the drawings are illustrative only. In particular, the embodiments included and described, have been chosen in order to best explain the principles, features, and characteristics of the invention, and its practical application, to thereby enable skilled persons to best utilize the invention and a wide variety of embodiments providable that are based on these principles, features, and characteristics. Accordingly, all variations possible are contemplated as being part of the invention, limited only by the scope of the appended claims.

### SUMMARY OF THE INVENTION

In accordance with the present invention, a cleanup aid is structured having a plurality of available fully disposable sack forming sheets. In the most preferred embodiments of the invention each sack forming sheet is square. A sack forming sheet is placed in a deployed position, spread out upon a ground surface, so that a volume of debris may be readily placed upon an upper surface of the sheet. Once a suitable volume of debris has been located upon the upper surface of a sack forming sheet, the corners are lifted, bunched, and secured, possibly with other edge proximate portions, forming a sack holding a volume of debris that is ready for disposal. Importantly, the present invention eliminates the need to load and fill individual bags—providing a significant reduction in time and effort required to securely ‘package’ the debris for removal.

The debris cleanup aid of the invention is contemplated to provide sack forming sheets in any of a number of possible configurations, including:

a) a stack of superposed individual sack forming sheets with one placed upon another;

b) a roll of sheet material, with each sack forming sheet established upon the roll of sheet material by a spaced, transversely oriented frangible separation line provided at a second end of a respective sack forming sheet;

c) a sheet material arranged as a plurality of z-folded sections, with each z-folded section separable from adjacent sections by way of a transversely oriented frangible separation line formed at a second end of a respective z-folded section of the sheet material; and

d) other providable arrangements wherein a plurality of sack forming sheets may be stowed for individual or group deployment and use.

Another aspect of the invention calls for the inclusion of a protective ground contacting tarp having a substantially rectangular shape when positioned in an unfurled state. The ground contacting tarp is arranged with a bottom surface configured for contacting the ground, and an upper surface upon which at least one sack forming sheet is placed. The sack forming sheet is preferably sized to substantially superpose and coextensively cover the upper surface of the ground contacting tarp so that the cleanup aid of the invention may be moved (dragged) about a selected cleanup area without any damage occurring to the sack forming sheet or sheets placed upon the ground contacting tarp.

Accordingly, when included, the ground contacting tarp is preferably structured of a material that is heavier and or stronger than the sheet material employed to provide the sack forming sheets. For example, while the sack forming sheets may be provided by a thin (e.g., 0.1 to 2 mils) plastic sheeting material, the tarp may be provided by a heavy nylon or plastic tarp that is much heavier then each of the individual sack forming sheets.

In addition to the ground contacting tarp, a means may further be included for enabling an individual to move the cleanup aid about a selected area to each of a plurality of debris pickup locations. A pattern and number of locations may be dictated by the requirements of the cleanup task being performed. The means may be fixed to the ground contacting tarp enabling one or more deployed sack forming sheets supported by the tarp to be moved to a succession of locations, and employed for securing a volume of debris at each location. In preferred embodiments of the invention this means may include a preferably substantially rigid rod that is coupled to the ground contacting tarp and structured with a handle portion coupled to the rod by way of one or more sections of rope, cable, etc.

It is important to note that the means for enabling an individual to move the cleanup aid about an area containing debris may be embodied in a variety of fashions. For example, a most simple embodiment of this means may include an extended portion of the tarp, which tapers as it extends from the main (rectangular) portion. As such, this extended portion may be triangular or trapezoidal in shape, preferably with a tapered end portion having some form of grasping portion or structure provided thereat.

When at least one sack forming sheet is in a deployed (ready to use) position, it may be desirable to maintain the sheet in position, even in the presence of a wind. For embodiments that include a ground contacting tarp, the sack forming sheet may be held in the deployed position by including at least one retaining clip. Each included retaining clip that is provided may be best placed along and proximate to edge portions of both the ground contacting tarp and the sack forming sheet(s). Of course, the clips would be arranged for enabling the secured edge portions (held by retaining clips) to be readily freed in order to form a sack using one or more the sack forming sheet when desired.

When considering the use of the invention in the presence of wind, a number of arrangements may be provided for maintaining a sack forming sheet in a deployed (spread out) position. For example, common spikes (such as those used with tents) may be employed. Each spike may be placed through holes provided during manufacture of the invention, or forced through user created puncture holes. Alternately weights may be provided for this purpose. In each case, the spikes, weights, etc., may be placed on or proximate to a plurality of corners and or edge locations of each deployed sack forming sheet. When considering embodiments that include a ground contacting tarp, at least one of the following may be provided upon the tarp:

a) reinforced holes, through which spikes may placed, may be provided at locations such at the corner locations of the tarp;

b) one or more weights may be fixed to a plurality of corner and or edge locations.

Skilled individuals may certainly be able to provide other possible structures and arrangements for maintaining sack forming sheets and or a ground contacting tarp in a deployed and unfurled position in the presence of wind.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 is a perspective view of an embodiment of a cleanup aid in accordance with the invention depicted in a partially unfurled state and partially spread out upon a ground surface.

FIG. 2 provides a perspective view of an embodiment as depicted in FIG. 1 in a fully unfurled state, and being pulled by an individual to one of a possible plurality of debris pickup locations of a selected area.

FIG. 3 illustrates an embodiment of the present invention with a pile of yard debris positioned in a center portion, upon an upper surface of a sack forming sheet prior to being secured by the sack forming sheet.

FIG. 4 shows the pile of debris of FIG. 3 after corner and or edge proximate portions of the sack forming sheet have been lifted, bunched, and secured, thereby forming a sack in accordance with the invention.

FIGS. 5A and 5B each depict a superposed stack of sack forming sheets that may be stacked, as shown, upon a ground contacting tarp.

FIG. 6 provides an illustration of another preferred embodiment of the invention in a fully unfurled state wherein the plurality of sack forming sheets are formed upon a roll of sheet material.

Partial List of Reference Numerals

10a,10b —(yard debris) cleanup aid

14—roll (formed by furled 10a,10b)

16—annular retaining loop

18—(protective) ground contacting tarp

18a—extended edge portion of 18

20—(substantially rigid) rod

22—grommet reinforced hole

24—sack forming sheet

24a—stack of sack forming sheets

24aa—first end of 24

24ab—second end of 24

25—corners of 24

26—retaining clips

28—user graspable rope

30—pile or volume of debris

32—plurality/pouch of ties

32a—zipper

34—tie

40—sack

46—handle or grasp

124—roll of sheet material (and sack forming sheets)

126—frangible separation line or perforation

### DETAILED DESCRIPTION OF EMBODIMENTS OF THE INVENTION

It is important to establish the definition of a number of descriptive terms and expressions that will be used throughout this disclosure. The term ‘debris’ which is to be broadly defined, may include a large variety of items that are to be secured for removal and disposal. The term ‘yard debris’ is to be assumed to include one or more of leaves, twigs, small branches, and a variety of tree and bush droppings (including acorns, pine-cones, needles, fruits, nuts, samara, pods, and or capsules). Importantly, the present invention may be employed for securing a large variety of debris items, with common yard debris representing a subset thereof. The term ‘sack forming sheet’ is to be defined as a sheet of any suitable material upon which debris may be placed, and subsequently a plurality of corners 25 and or edge proximate portions may be lifted, bunched and secured. The acts of lifting, bunching and securing the bunched corner 25 and edge portions, results in the forming of a ‘sack’ 40 in accordance with the invention. Accordingly, a sack 40 of the present invention is formed of an essentially flat sheet of material, formed of plastic, paper, treated paper, etc., that may be utilized to form a sack. Skilled individuals may note that a sack formed of a sack forming sheet of the invention may typically provide a plurality of slits or partial openings, providing for the passage of air and moisture. The term ‘ground surface’ in the context of this disclosure may be assumed to include surfaces such as dirt, sand, grass/lawn, cement, asphalt, brick, and or blacktop. Other important terms and definitions will be provided, as they are needed, to properly define the present invention and its associated novel characteristics and features.

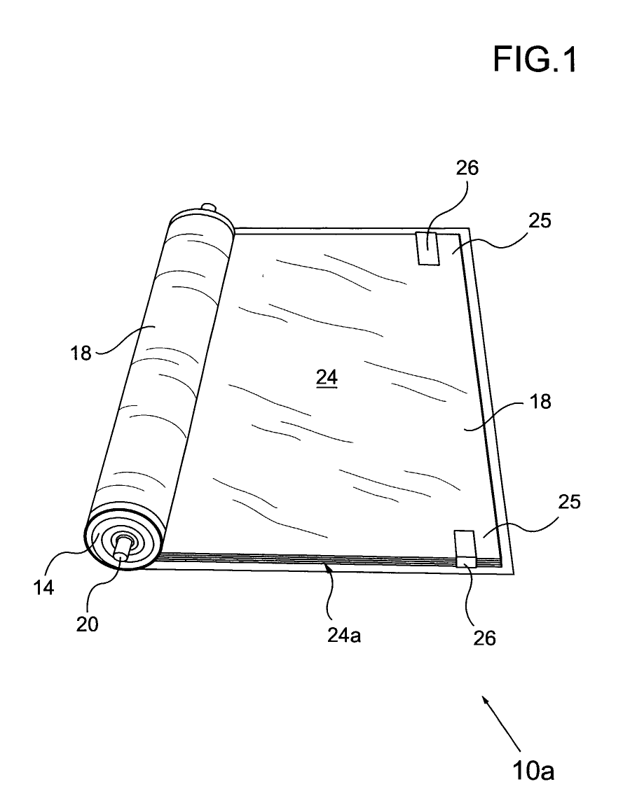

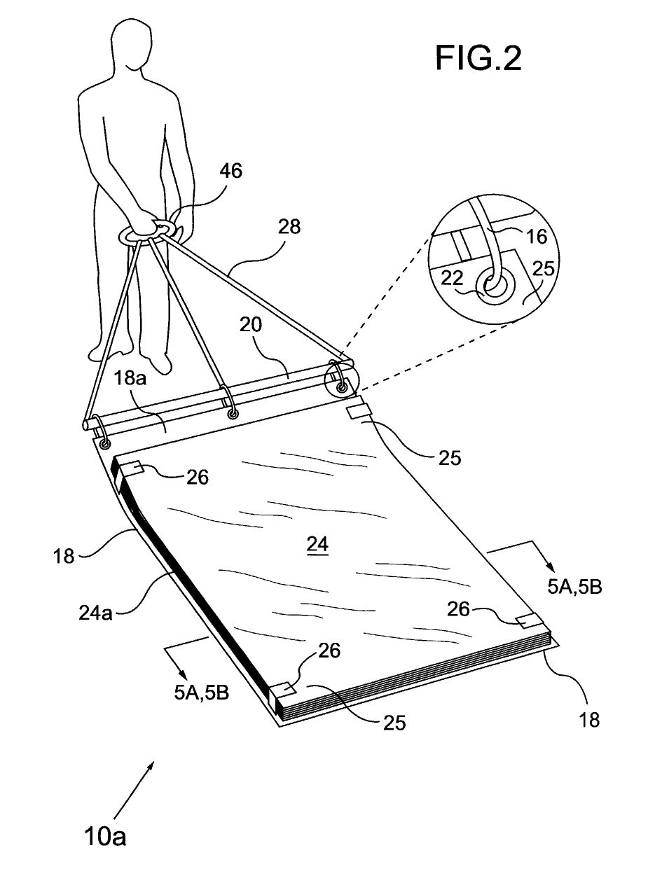

Referring now to the drawings, FIG. 1 depicts a first preferred embodiment of the invention. Illustrated is a cleanup aid 10a including a plurality of stacked sack forming sheets 24, which in this embodiment are arranged as a stack of separate superposed sack forming sheets, with one placed upon the next. The stack 24a of sack forming sheets 24 is best shown in FIGS. 2 through 5B.

The cleanup aid 10a of FIG. 1 is depicted in a partially unfurled state or position. This is indicated by the roll 14 formed of an unfurled portion of the cleanup aid 10a. It may be noted that in the furled state (e.g., fully rolled up) the cleanup aid 10a may be easily transported and stored. When the cleanup aid 10a is in the unfurled state, as clearly shown in FIGS. 2, 3, and 4, a sack forming sheet 24 is provided in a deployed position such that a volume of yard debris 30 may be piled upon an upper surface of the sack forming sheet 24 for securing thereby.

Also shown in FIG. 1, but more clearly depicted in FIGS. 2, 3, and 4, is a rod 20. The rod 20 may be constructed of plastic, metal, wood, etc., as desired, and may most preferably be substantially rigid in construction. Further, a possibly most preferred embodiment of the rod 20 may provide for a multi-piece design that is foldable for carrying and storage (not explicitly illustrated). Importantly, the rod 20 may be provided as a portion of a ‘means for enabling an individual to move the cleanup aid 10a’ about a selected area, to one or more locations at which debris will be loaded upon a sack forming sheet 24 and secured. As illustrated, a number of simple arrangements may be provided for coupling items of the means, such as the rod 20, to the ground contacting tarp 18. For example, as shown in FIG. 2, at a plurality of spaced locations along an extended edge portion 18a, a grommet reinforced hole 22 may be employed along with an annular retaining loop 16 that is passed there the grommet and looped around the rod 20. Clearly numerous methods for securing the rod 20 to the ground contacting tarp 18 may be provided by skilled individuals. In addition, it is certainly contemplated that a rod 20 may be provided such that a user simply grasps the rod 20, possibly directly (e.g., not via a rope 28 and grasp 46) and lifts a proximate portion of the cleanup aid 10a enabling the user to drag the cleanup aid to a next selected location for securing debris thereat.

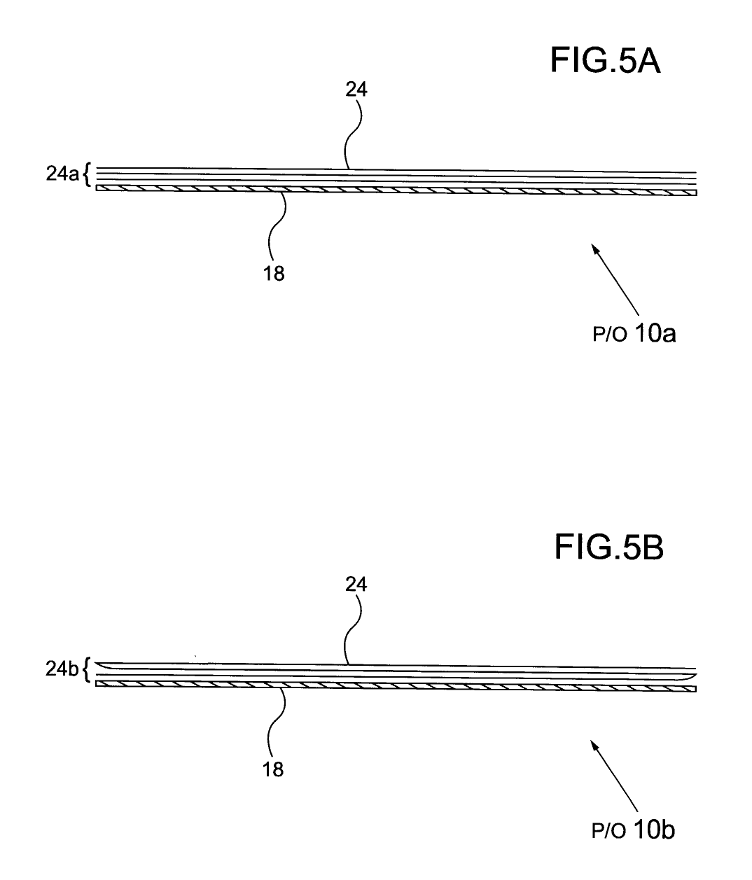

With heavy use, and the repeated moving and dragging of the cleanup aid 10a (and other embodiments such as 10b of FIG. 5B) about a cleanup area, the ground contacting tarp 18 may become worn and need replacing. A replacement of the ground contacting tarp 18 may include the removal or cutting of the annular retaining loops 16, a replacing of the ground contacting tarp 18, and the applying of a new plurality of annular retaining loops 16.

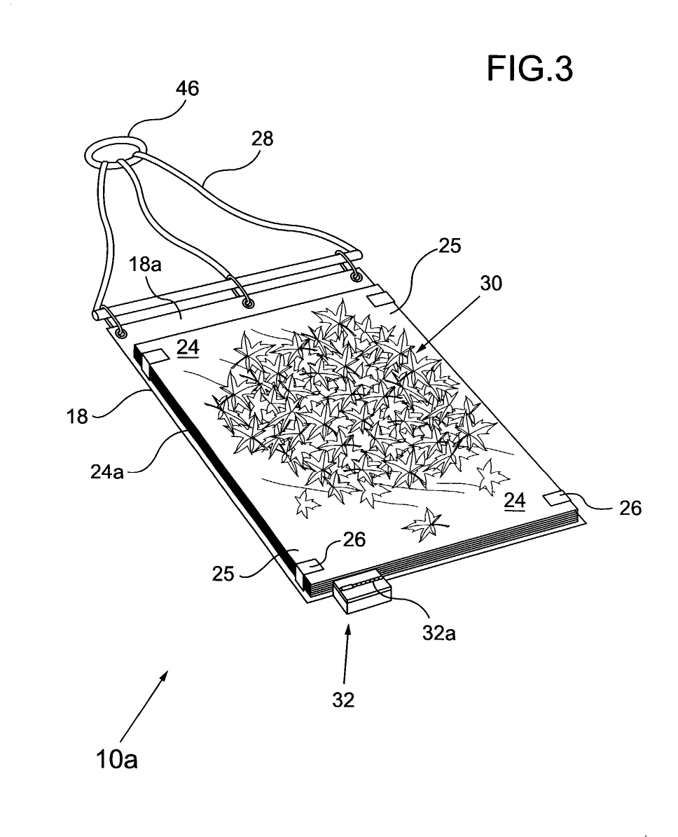

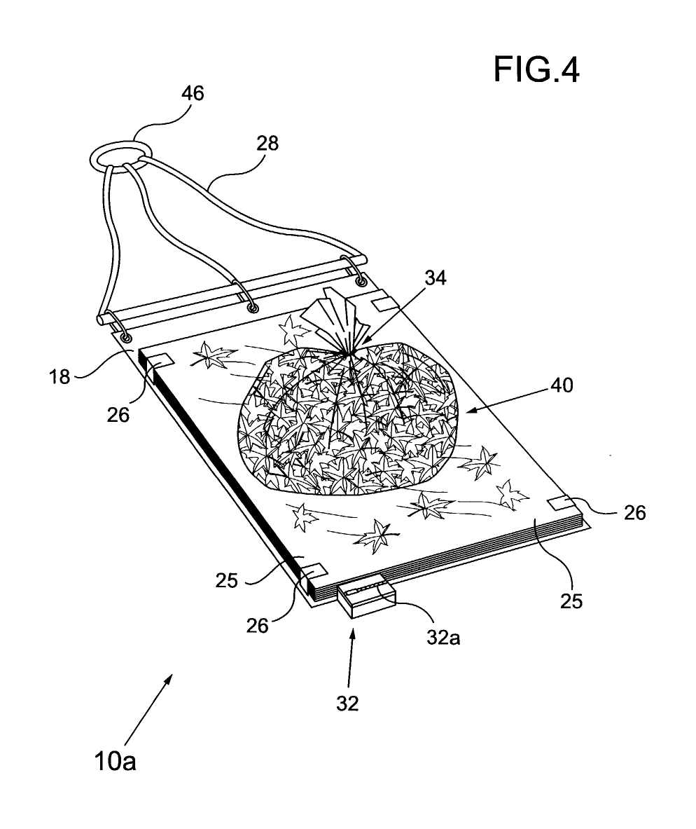

One exemplary version of the means for enabling an individual to move the cleanup aid 10a about an area to be cleaned-up is illustrated in FIGS. 2 through 4. This embodiment may include at least one section or length of rope 28 (or functional equivalents), and a hand grasp 46, which may also be termed a handle. It may be noted that the rope or ropes 28 and hand grasp 46 may be termed a ‘grasping portion’. As shown in FIG. 2, once the cleanup aid 10a is in an unfurled state, the means for enabling an individual to move the cleanup aid 10a about a selected area may be grasped by a user, enabling the user to move (e.g., drag) the cleanup aid 10a to a desired location. Once positioned at the location, one or more of a plurality of sack forming sheets 24, depicted in this embodiment as a stack 24a of sack forming sheets, are or may be made available for use in securing a volume of debris 30 for subsequent removal. In FIG. 3, a volume of yard debris 30 is depicted loaded upon a center portion or region of an upper surface of the sack forming sheet 24. Next, the corners 25 and or edge proximate portions of the sack forming sheet 24 may be lifted, bunched, and secured, so that the sack forming sheet forms a sack 40, as shown in FIG. 4. Accordingly, in the process of lifting the corners 25, gathering and/or bunching the corner 25 and other edge proximate portions of the sack forming sheet 24, and securing the bunched portions, a sack 40 is formed containing the volume of debris 30 which are now ready for removal and disposal.

Referring again to FIG. 4, it may be preferable to construct each of the plurality of sack forming sheets 24 from a clear plastic sheet material, thereby enabling an individual to visually examine and inspect the contents of each sack 40 that is formed by a respective sack forming sheet 24. In addition, if a heavy volume of debris 30 is to be secured, a plurality of sack forming sheets 24 may be utilized to form a heavy duty, multi-layer sack (not explicitly illustrated), which may still be readily visually inspected. It may also be noted that sack forming sheets 24 of the invention may preferably be provided as having a substantially square shape. A possibly most preferable embodiment of a square sack forming sheet 24 of the invention would be provided with each side being from 7 to 10 feet in length (establishing an area of 49 to 100 square feet).

It is important to note that the sack forming sheets 24 of the invention may be deployed directly upon the ground surface should the ground contacting tarp not be included. When the cleanup aid 10a is used in this manner one or more bottom sack forming sheets of the stack may become worn and thereby possibly unusable for securely containing a particular volume of debris 30. In addition, the sack forming sheet 24 may be provided, preferably as shown in FIG. 5A or 5B, in packs of 3, 4, 5 or more. For example, if a pack contains 3 sack forming sheets, the pack may be used to provide 1 heavy duty (multi-layer) sack 40, or 3 lighter duty sacks, as required for the volume of debris 30 being secured.

In order to maintain one or more sack forming sheets 24 in a ready to use position when deployed, even in the presence of wind, it may be desirable to provide additional structures. For example, when considering embodiments not including the ground contacting tarp 18, one simple and easy to use approach for maintaining each sack forming sheet 24 in the deployed position may utilize common spikes (such as those used with tents and canopies). Each spike may be placed through holes formed during the manufacture of the sack forming sheets, or equivalently forced through user created (puncture) holes. Alternately a plurality of weights may be provided that may be placed upon corner 25 and edge positions of the deployed sack forming sheet(s) 24.

When considering embodiments that include a ground contacting tarp 18, reinforced holes, through which the spikes may placed, may be provided at locations such at the corner 25 and edge locations of the tarp. Also, as discussed hereinabove, one or more weights may be placed upon, or most preferably fixed to, a plurality of corners 25 and or edge locations of the ground contacting tarp 18.

As would be appreciated by skilled persons, a number of possible structures and arrangements for maintaining sack forming sheets 24 and or a ground contacting tarp 18 in a deployed and unfurled position in the presence of wind are certainly providable. A possibly most preferred arrangement that may be employed with embodiments that include a relatively heavy weight ground contacting tarp 18 include a plurality of retaining clips 26. As can be seen in FIGS. 1 through 4, one or more sack forming sheets 24 may be held in the deployed position by including at least one retaining clip 26. Each clip 26 provided may be best placed along and proximate to edge portions and or corners 25 of the ground contacting tarp 18 and the sack forming sheet(s) 24. Of course, the retaining clips 26 and or the sack forming sheet 24 would be structured for enabling secured edge portions to be freed, when desired, for forming a sack 40 with one or more sack forming sheets 24.

As implied in FIG. 2, and explicitly shown in FIGS. 5A and 5B, a stack of sack forming sheets 24 may be provided by one or more of:

a) a simple stack of superposed, individual, and most preferably fully disposable sack forming sheets 24, with one individual sheet placed upon a next sheet forming the stack 24a; and

b) a stack 24b of sack forming sheets 24 formed of a z-folding of a plurality of adjacent sections of the sheet material, wherein one sack forming sheet is folded upon a next sack forming sheet, with each z-folded section separable from an adjacent section by way of a transversely oriented frangible separation line formed at a second end of each section of the sheet material, thereby forming a respective sack forming sheet 24 that may be quickly separated from other sack forming sheets of the stack 24b of the invention.

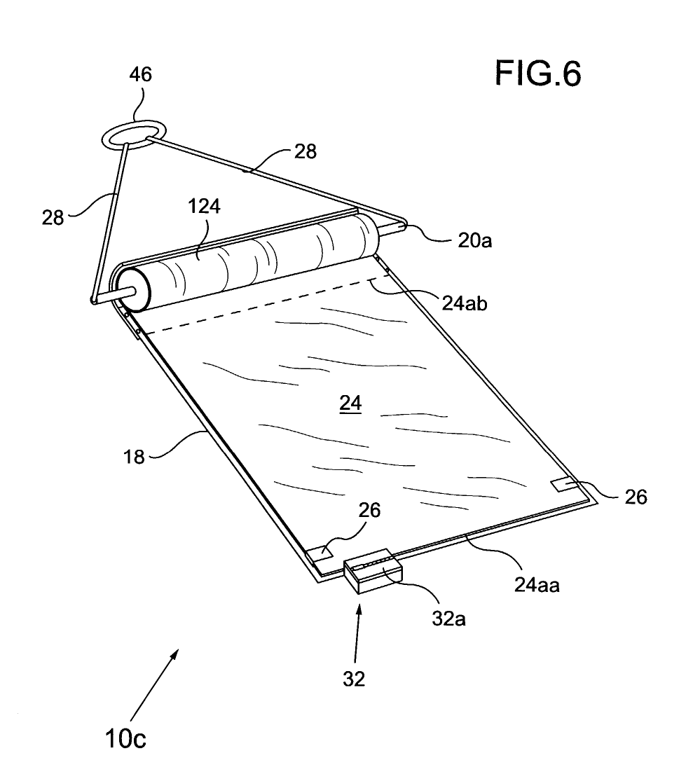

Turning now to FIG. 6, yet another embodiment of the invention is depicted. The cleanup aid 10b of FIG. 6 includes a roll of sheet material 124 providing a plurality of sack forming sheets 24. Each sack forming sheet 24 is established upon the roll of sheet material 124 by a transversely oriented frangible separation line 126, which is provided at a second end 24ab of a respective sack forming sheet 24. Accordingly, each separation line 126 is spaced so as to provide a plurality of substantially rectangular sack forming sheets 24 stored or available in a roll form.

It is important to note that a most preferred shape for each sack forming sheet 24 provided, whether upon the roll 124 or via a stack 24a, is substantially square. However, other shapes including circular and hexagonal (not illustrated) may also be employed and is certainly considered within the scope of the invention.

As clearly shown in FIGS. 4 and 6, a packet 32 containing a plurality of ‘ties’, may be included and possibly fixed to the cleanup aids 10a, 10b, or 10c. As shown, the packet 32 may include a zipper 32a that may be opened to access one of the plurality of ties 34 contained within the packet 32. It must be understood that the packet 32 is exemplary of many arrangements and configurations in which each tie 34 may be readily made available. After a lifting and bunching of corners 25 and edge proximate portions of a sack forming sheet 24, a securing of the bunched portions forming of a sack 40 containing a volume of debris 30 may be effected by a tie 34, as depicted in FIG. 4. As a skilled person will appreciate, the ties 34 in accordance with the invention may be realized by any of a plurality of available or providable embodiments.

While there have been described herein a plurality of the currently preferred embodiments of the present invention, along with contemplated methods of operation and use, those skilled in the art will recognize that other and further modifications may be made without departing from the invention. For example, the sack forming sheets may be provided as paper, plastic, etc., and may even be provided in a very porous, net or net-like, yet tough configuration. These other providable ‘sack forming sheets’ are intended to certainly be considered sack forming sheets in accordance with the invention. Another contemplated modification may be provided in the manner in which the means for moving the cleanup aid about a selected area is structured. For example, the arrangement of FIG. 2, including the ropes 28 and handle 46, may be alternately provided as a simple extended portion (not illustrated) of the tarp 18. For example, one preferred embodiment would provide an extended portion, which tapers as it extends from the main (rectangular) portion. The extended portion would most preferably be provided as a substantially triangular or trapezoidal extension, which tapers to an end portion, possibly having some form of grasping structure provided for a user to grasp when needing to move the cleanup aid to a next location.

Accordingly, the foregoing descriptions of the specific embodiments of the present invention have been presented for the purposes of illustration, description, and enablement. They are not intended to be exhaustive or to limit the invention to the specific forms disclosed and or illustrated. Obviously numerous modifications and alterations are possible in light of the above teachings, and it is fully intended to claim all modifications and variations that fall within the scope of the appended claims provided hereinafter.

what is claimed is:

1. A cleanup aid, structured for enabling debris to be secured for removal, the cleanup aid comprising:
a) a plurality of sack forming sheets, with each sack forming sheet deployable for use in securing a volume of debris;
b) each sack forming sheet placeable in an unfurled state and deployable such that the volume of debris may be piled upon an upper surface thereof, with the corners of the sack forming sheet arranged for subsequent lifting, bunching, and securing, thereby forming a sack containing the volume of debris.

2. The cleanup aid in accordance with claim 1, wherein each provided sack forming sheet is substantially square in shape.

3. The cleanup aid in accordance with claim 2, wherein the plurality of sack forming sheets are provided as a stack of superposed sack forming sheets.

4. The cleanup aid in accordance with claim 3, wherein the plurality of stacked and superposed sack forming sheets are maintained in position, even in the presence of a wind, by employing at least one of:
a) a plurality of retaining clips;
b) a plurality of spikes; and
c) at least one weight.

5. The cleanup aid in accordance with claim 3, wherein each of the plurality of stacked and superposed sack forming sheets are structured of a clear plastic sheet material, thereby facilitating visual examination and inspection of the contents of each sack that is formed by a respective sack forming sheet.

6. The cleanup aid in accordance with claim 3, further including a protective ground contacting tarp, wherein the stack of sack forming sheets are located upon and superposing the protective ground contacting tarp when the ground contacting tarp is positioned in an unfurled state and spread out over a ground surface.

7. The cleanup aid in accordance with claim 6, further including means for enabling an individual to move the cleanup aid about a selected area to at least one location at which debris will be loaded upon an upper surface of a sack forming sheet and secured thereby.

8. The cleanup aid in accordance with claim 7, wherein the means includes:
a) a rod that is fixed to an extended edge of the ground contacting tarp; and
b) a length of rope having a first end and a second end, with the first end of the rope fixed to the rod proximate to a first end of the rod and the second end of the rope is fixed proximate to a second end of the rod.

9. The cleanup aid in accordance with claim 1, wherein the sack forming sheets are provided by a roll of sheet material, with each sack forming sheet established upon the roll of sheet material by a transversely oriented frangible separation line provided at a second end of each respective sack forming sheet.

10. The cleanup aid in accordance with claim 9, wherein each provided sack forming sheet is substantially square.

11. The cleanup aid in accordance with claim 10, further including a plurality of ties, with each tie available for securing a bunched plurality of corners and edge proximate portions of a sack forming sheet, thereby forming and maintaining a sack formed by the sack forming sheet.

12. A cleanup aid, structured for enabling a volume of debris to be secured for removal, the cleanup aid comprising:
a) a protective ground contacting tarp having a substantially rectangular shape when positioned in an unfurled state and spread out over a ground surface; and
b) at least one deployable sack forming sheet, the sack forming sheet positionable so as to superpose and substantially cover an upper surface of the ground contacting tarp, thereby being protected by the tarp when in a deployed position;
c) the sack forming sheet available so that a volume of debris may be piled upon an upper surface thereof, with corners and proximate edge portions of the sack forming sheet arranged for subsequent lifting, bunching, and securing, thereby forming a sack containing the volume of debris.

13. The cleanup aid in accordance with claim 12, wherein each provided sack forming sheet is substantially square in shape.

14. The cleanup aid in accordance with claim 12, wherein a plurality of sack forming sheets are provided as a stack with one sheet placed upon a next sheet, the stack positionable upon, and securable to, the ground contacting tarp.

15. The cleanup aid in accordance with claim 14, wherein the plurality of stacked and superposed sack forming sheets are maintained in deployed position upon the ground contacting tarp by retaining clips, with each clip placed along and proximate to edge portions of the ground contacting tarp and the sack forming sheets.

16. The cleanup aid in accordance with claim 14, wherein each of the plurality of sack forming sheets are structured of a clear plastic sheet material, thereby facilitating visual examination and inspection of a volume of debris secured within each sack that is formed by a respective sack forming sheet.

17. The cleanup aid in accordance with claim 14, wherein the stack of sack forming sheets are formed of a z-folding of a plurality of sections of a sheet material, with each z-folded section separable from adjacent sections by way of a transversely oriented frangible separation line formed at a second end of each section of the sheet material.

18. The cleanup aid in accordance with claim 12, wherein each sack forming sheet is provided by a roll of sheet material, with each sack forming sheet established upon the roll of sheet material by a spaced and transversely oriented frangible separation line provided at a second end of a respective sack forming sheet, with each spaced separation line located so as to provide a plurality of substantially rectangular sack forming sheets contained in the roll of the sheet material.

19. The cleanup aid in accordance with claim 18, wherein each provided sack forming sheet is substantially square.

20. The cleanup aid in accordance with claim 18 further including a plurality of ties, with each tie available for applying to a bunched plurality of corners and proximate edge portions of a sack forming sheet to be securely fastened together, thereby securely maintaining a sack formed by the sack forming sheet.

21. A debris cleanup aid, comprising:
a) a plurality of sack forming sheets, arranged as a superposed stack of sack forming sheets with one sheet placed one upon the next sheet; and
b) a ground contacting tarp, sized be substantially the same size as the sack forming sheets;
c) the ground contacting tarp positioned under and superposed by the stack of sack forming sheets with a bottom surface of the tarp contacting a ground surface of the area wherein the tarp is in placed in an unfurled state.

22. The debris cleanup aid in accordance with claim 21, further including means for enabling an individual to move the debris cleanup aid about a selected area to each of a plurality of debris pickup locations, as required, to effect a cleaning up of debris within the selected area.

23. The debris cleanup aid in accordance with claim 22, wherein the means includes:
a) a rod that is coupled to the ground contacting tarp along an extended edge thereof; and
b) a grasping portion coupled to the rod for grasping by the individual for facilitating the moving of the cleanup aid to a next cleanup location.

24. The debris cleanup aid in accordance with claim 23, wherein the grasping portion includes at least one length of rope.

25. The debris cleanup aid in accordance with claim 23, wherein the plurality of sack forming sheets, and the ground contacting tarp are arranged to be readily wrapped around the rod, placing the sheets and tarp in a furled state, facilitating the easy storage and transporting of the debris cleanup aid.

26. The debris cleanup aid in accordance with claim 25, wherein the rod is structured to be foldable.

27. The debris cleanup aid in accordance with claim 21, wherein the plurality of stacked and superposed sack forming sheets are maintained in position, even in the presence of a wind, by retaining clips.

28. The debris cleanup aid in accordance with claim 21, wherein the ground contacting tarp is constructed of a heavy sheet material, that will not be easily lifted in the presence of a wind.

29. The debris cleanup aid in accordance with claim 21, wherein each of the plurality of stacked and superposed sack forming sheets are formed of at least one of:
a) a clear plastic sheet material;
b) a paper sheet material; and
c) porous net-like material.

30. The debris cleanup aid in accordance with claim 21, further including a plurality of ties, with each tie arranged for securing a bunched plurality of corners and other portions of a sack forming sheet, thereby forming and maintaining a sack securely containing a volume of debris.

31. A method of securing a volume of debris for removal and disposal, the method including the steps of:
a) deploying a sack forming sheet by spreading out a sack forming sheet upon a ground surface;
b) loading the volume of debris upon a center portion of an upper surface of the sack forming sheet;
c) lifting a plurality of at least one of:
i) corners of the sack forming sheet; and
ii) other edge proximate portions of the sack forming sheet;
d) bunching the lifted corners and other edge proximate portions of the sack forming sheet forming a sack; and
e) securing the bunched corners and other edge proximate portions thereby securely maintaining the sack containing the volume of debris.

32. The method as recited in claim 31, wherein the step of deploying the sack forming sheet includes unfurling a plurality of sack forming sheets provided as a stack.

33. The method as recited in claim 32, wherein each sack forming sheet deployed during the deploying step is square.

34. The method as recited in claim 32, wherein the step of lifting the corners and other edge proximate portions of the sack forming sheet involves the lifting of the corners and edge proximate portions of a plurality of sheets, thereby forming a heavy duty, multi-layer sack.

35. The method as recited in claim 31, wherein the step of securing the bunched corners and edge proximate portions is realized by utilizing an available tie.
